(19) United States
(12) Patent Application Publication
(10) Pub. No.: US 2004/0020239 A1
(43) Pub. Date: Feb. 5, 2004

(54) Method of producing an oxygen-enriched air stream

(76) Inventors: Craig Steven LaForce, Flemington, NJ (US); Charles Brooks, Broken Arrow, OK (US)

Correspondence Address: The BOC Group, Inc., Joshua L. Cohen - Intellectual Property, 100 Mountain Avenue, Murray Hill, NJ, 07974, US

(21) Appl. No.: 10/383,336

(22) Filed: Mar. 7, 2003

Related U.S. Application Data
(60) Provisional application No. 60/362,736, filed on Mar. 8, 2002.

(51) Int. Cl. F02G 3/00; F02B 43/00; F25J 3/00

(52) U.S. Cl. 62/648; 60/39.12

(57) ABSTRACT

The present invention provides a method of producing an oxygen-enriched air stream which includes compressing an air stream, dividing the compressed air stream into a first portion and a second portion, separating the second portion of the air stream to provide an oxygen gas product, introducing the oxygen gas product into the first portion of the compressed air stream to form an oxygen-enriched air stream, and then introducing the oxygen-enriched air stream to the process equipment, which may be by way of example a blast furnace.

### CROSS-REFERENCE TO RELATED APPLICATIONS

This application claims the benefit of U.S. Provisional Application No. 60/362,736, filed Mar. 8, 2002.

### BACKGROUND OF THE INVENTION

The present invention relates to an oxygen-enriched air stream generated for use in process equipment.

Powdered coal injection has increasingly been used in existing blast furnaces in order to reduce the amount of coke necessary for the production of iron from the ore. With coal injection, the air supplied to the blast furnace has to be enriched with oxygen in order to maintain furnace capacity at a desired level.

### SUMMARY OF THE INVENTION

The present invention provides a method of producing an oxygen-enriched air stream which includes compressing an oxygen-enriched air stream, dividing the compressed oxygen-enriched air stream to a first portion and a second portion, separating the second portion of the oxygen-enriched air stream to provide an oxygen gas product, introducing the oxygen gas product into the first portion of the compressed oxygen-enriched air stream to form a second oxygen-enriched air stream, and then introducing oxygen-enriched air stream to the process equipment, which may be by way of example a blast furnace.

### BRIEF DESCRIPTION OF THE DRAWINGS

For a more complete understanding of the present invention, reference may be had to the description of the invention taken in conjunction with the following drawings, of which:

FIG. 1A is a schematic diagram illustrating two stages of oxygen-enrichment for a feed stream of a blast furnace according to the present invention;

FIG. 1B is a schematic diagram illustrating a method of the present invention; and

FIG. 1C is a schematic diagram of another embodiment of the present invention.

### DESCRIPTION OF THE INVENTION

The present invention relates to an oxygen-enriched air stream generated by integrating an air blower from a blast furnace with an air separation unit (ASU).

The blast furnace air blower is used to produce a compressed oxygen-enriched feed stream, a portion of which is introduced into the ASU to produce an oxygen product. The oxygen product is then combined with the remaining portion of the compressed oxygen-enriched feed stream to generate another oxygen-enriched feed stream, which can be used for blast furnace operation. The invention provides a relatively low cost solution to retrofit existing blast furnaces for operation with enhanced oxygen-enrichment.

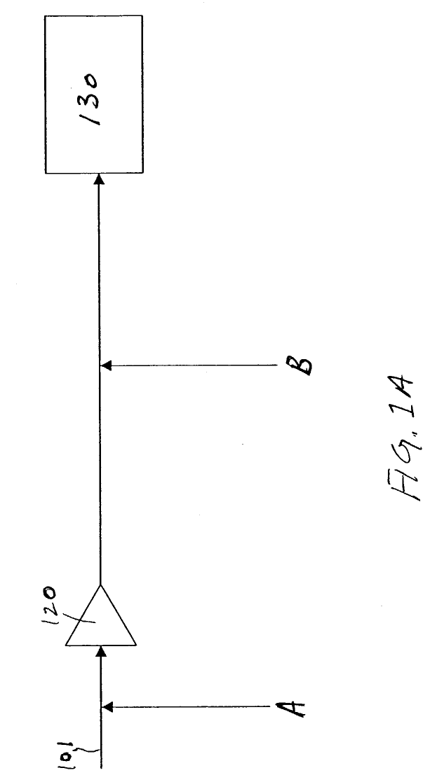

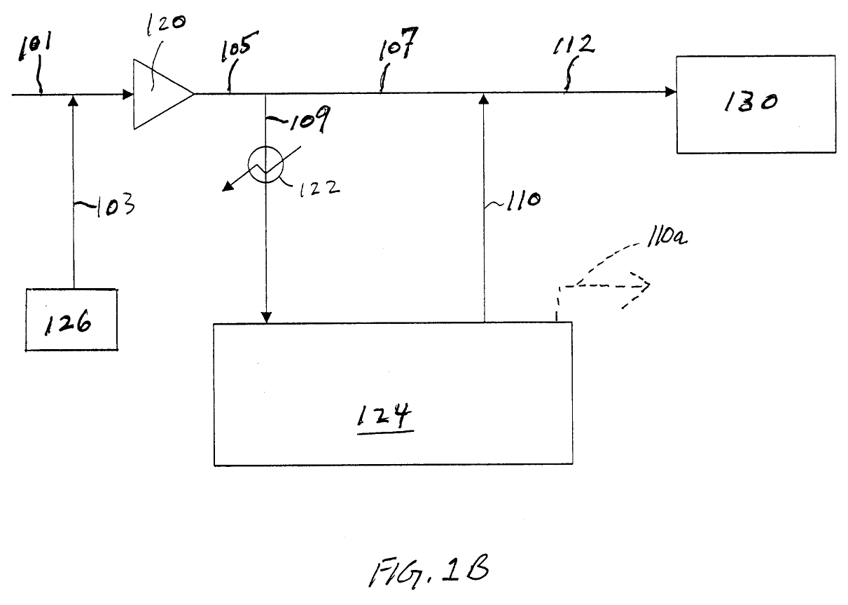

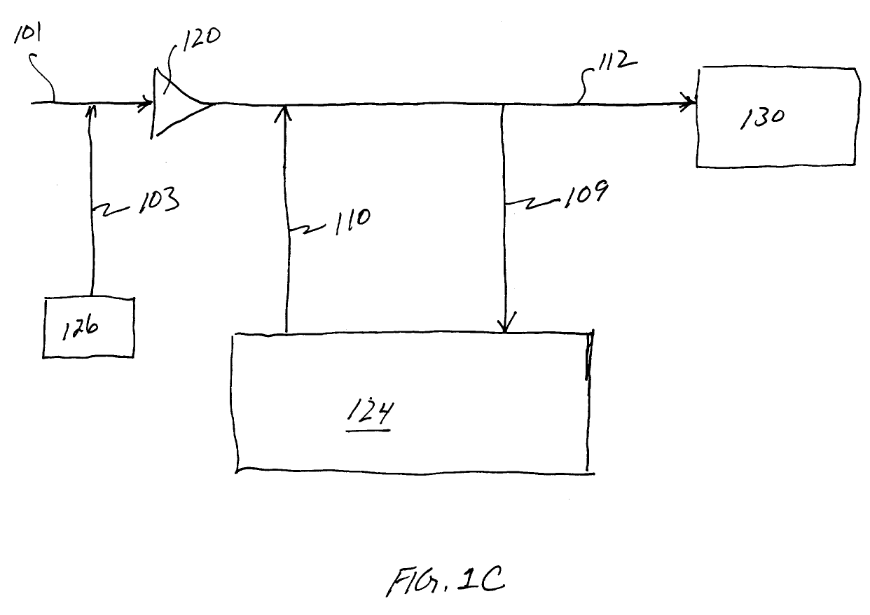

Referring to FIG. 1A, there is shown two-stage oxygen enrichment for a feed air stream to a blast furnace. In a regular blast furnace operation, a normal feed air stream 101 is compressed by an air blower 120 to produce a compressed feed air stream that is introduced into a blast furnace 130.

For operation with oxygen-enriched feed air, additional oxygen can be provided to the feed stream at two different stages—either upstream or downstream of the air blower 120, as indicated respectively by streams A and B in FIG. 1A according to the present invention.

In the first stage, an oxygen-containing stream A, with an oxygen concentration higher than that of air, is provided at the inlet of the air blower 120. Since the air blower 120 often has excess compression capacity in the oxygen enriched mode, it can be used to compress the additional oxygen-containing stream A along with the normal air feed 101 to the blast furnace 130. However, since existing blowers to blast furnaces are generally not designed for enriched oxygen service, there is a limit to the amount of oxygen enrichment that can be achieved in this manner. Thus, further oxygen-enrichment is achieved in a second stage by providing additional oxygen downstream of the air blower 120, as shown by the oxygen-containing stream B as shown in the present invention.

FIG. 1B shows an embodiment of the present invention. The air compressor 120 provides compression for a combined gas stream containing the normal feed air stream 101 and an oxygen-containing stream 103 (with oxygen concentration C1 higher than that of air). The oxygen-containing stream 103 can generally be an oxygen-enriched air stream, such as discussed with respect to the upstream stage A of FIG. 1A, or an oxygen gas supplied from a source 126 capable of providing the desired level of oxygen-enrichment and capacity. For example, the source 126 may be a cryogenic or non-cryogenic system, e.g., an ASU or a pressure swing adsorption (PSA) unit, among others.

The air blower 120 compresses the combined streams 101 and 103 to produce another oxygen-enriched air stream 105 (with oxygen concentration C2 that is lower than C1), e.g., at a pressure between about 3 and about 4.5 barg, and a temperature of between about 200° C. to about 250° C. The oxygen concentration of the compressed stream 105 depends on the feed rates of the streams 101, 103, and the oxygen concentration of the oxygen-containing stream 103. Under typical operating conditions for the air blower 120, and depending on the amount and purity of additional oxygen provided as the input, an oxygen concentration of between about 22 and 26% for the compressed stream 105 can readily be achieved, with the oxygen enrichment being limited from a flammability and compressor material safety perspective for existing blast air blowers.

According to the present invention, instead of introducing the compressed stream 105 directly to the blast furnace 130, additional oxygen enrichment is performed by diverting a portion of the compressed stream 105 as an input to an ASU 124. The ASU 124 is different from, i.e. separate and discrete from, the source 126, which is typically equipment that is part of an existing blast furnace facility. Such a configuration is possible because for most air blowers in existing blast furnace facilities, there is often additional compression capacity available in the air blower 120. Thus, as shown in FIG. 1B, the compressed oxygen-enriched air stream 105 is divided into two portions, a first portion 107 and a second portion 109. Portion 109 is cooled by a cooler 122 before being introduced as a feed stream into the ASU 124.

The ASU 124 may be of any general design that is capable of producing an oxygen product 110 with properties that are compatible with specific application requirements. For example, the ASU 124 may be a multiple product ASU that generates other products as well as oxygen, or it may be one that generates oxygen as the only product. If other products are not needed, as is typically the case for a blast furnace oxygen enrichment project, the ASU 124 preferably has a design that is optimized for producing oxygen only at a relatively narrow pressure range at a desired purity level. Furthermore, a flow scheme using internal compression of the oxygen product may also be a cost effective option. In addition, a dual reboiler ASU cycle tends to require lower air inlet pressure consistent with that available from the blast air blower, such that additional air compression can be greatly reduced or eliminated, thus providing savings in both capital cost and ASU power consumption.

Further distillation of the oxygen-enriched air portion 109 in the ASU 124 results in the formation of the oxygen product 110, with an oxygen concentration C3 that is considerably higher than oxygen concentration C2 for than that of stream 105. The oxygen product 110 is then combined with the other oxygen-enriched portion 107 to form yet another oxygen-enriched stream 112 (with oxygen concentration C4 higher than C2), which is then used as an input stream to the blast furnace 130. Alternatively, the oxygen product 110 may be used to provide oxygen enrichment to a different blast furnace (e.g., not serviced by air blower 120), or even to other process equipment or applications, as desired and indicated generally at 110a.

Another embodiment as shown in FIG. 1C involves interchanging the locations of the streams 109 and 110—i.e., having the input stream 109 to the ASU 124 located downstream of the location where oxygen product stream 110 is added to the blast air feed stream. The cooler 122 may also be used when the input stream 109 is so positioned for this embodiment.

As an example, if the oxygen-enriched stream 112 is used as an input to a blast furnace, a relatively low purity product from the ASU 124, e.g., with an oxygen purity between about 85% to about 98%, preferably about 90%, is typically sufficient. The oxygen product 110 is provided by the ASU 124 at a pressure slightly above that of the blast air stream, or sufficiently high to allow for control valve operations. For most blast furnace applications, the oxygen-enriched stream 112 may have an oxygen concentration between about 23% and about 28%.

Several advantages can be achieved through the integration of the air blower 120 with the ASU 124. For example, since oxygen-enriched air condenses at a lower pressure than air, distillation can be performed at a reduced air pressure in the ASU 124, leading to a reduced power consumption. By providing oxygen-enriched air as input to the ASU 124, it is likely that (depending on the cycle and product requirement) a fewer number of distillation stages may be required to produce the desired oxygen purity. Furthermore, by providing compression with the air blower 120, the need for a primary air compressor in the ASU 124 may be reduced, or even eliminated in some cases. Thus, both power and capital savings can be realized for generation of higher pressure oxygen from the ASU 124. By reducing the ASU power consumption (typically electrical) in favor of keeping design loads on the blast air blower (typically driven by steam which is produced as a byproduct of the mill), additional cost savings can be achieved because of the lower cost of steam as an energy source in a steel mill. Oxygen enrichment of blast furnace air is often done progressively in phases which may be separated by several years. The integration with an ASU as a second stage, second phase, enrichment can readily be retrofitted to existing blast furnace facilities with minimal disruption of the oxygen enrichment scheme which may be pre-existing.

While the present invention has been described with reference to one or more embodiments, numerous changes, additions and omissions may be made without departing from the spirit and scope of the present invention.

What is claimed is:

1. A method of producing an oxygen-enriched air stream for use in process equipment, comprising:
providing a first oxygen-enriched air stream from an oxygen source to an inlet of an air blower for a blast furnace;
producing a compressed oxygen-enriched air stream from said first oxygen-enriched air stream using said air blower;
dividing said compressed oxygen-enriched air stream into a first portion and a second portion;
introducing said second portion of said compressed oxygen-enriched air stream to an air separation unit to form an oxygen gas product, said air separation unit being separate and discrete from said oxygen source for said first oxygen-enriched air stream;
combining said oxygen gas product with said first portion of said compressed oxygen-enriched air stream to form a second oxygen-enriched air stream; and
providing said second oxygen-enriched air stream for said process equipment.

2. The method according to claim 1, wherein said oxygen gas product and said second oxygen-enriched air stream each have an oxygen concentration greater than an oxygen concentration of said compressed oxygen-enriched air stream.

3. The method according to claim 1, wherein an oxygen concentration of the compressed oxygen-enriched air stream is less than an oxygen concentration of said first oxygen-enriched air stream.

4. The method according to claim 1, wherein the second oxygen-enriched air stream has an oxygen concentration between about 23% to about 28%.

5. The method according to claim 1, further comprising:
introducing said second oxygen-enriched air stream to said process equipment.

6. The method according to claim 1, wherein providing said second oxygen-enriched air steam occurs downstream of introducing said second portion of said compressed oxygen-enriched air stream to an air separation unit.

7. The method according to claim 1, wherein said introducing said second portion of said compressed oxygen-enriched air stream to an air separation unit occurs downstream of said providing said second oxygen-enriched air stream for said process equipment.

8. The method according to claim 1, wherein the process equipment is a blast furnace.

9. A method of producing an oxygen-enriched air stream, comprising:
providing an air stream of a first stage, compressing the air stream to provide a compressed air stream, dividing said compressed air stream into a first portion and a second portion, separating said second portion of said compressed air stream to provide a gas product at a second stage separate and discrete from the first stage, introducing said gas product into said first portion of said compressed air stream to form a second air stream, and introducing said second air stream to said process equipment.
